(19) United States
(12) Patent Application Publication
(10) Pub. No.: US 2005/0075850 A1
(43) Pub. Date: Apr. 7, 2005

(54) Dynamic platform with a reality simulting device

(75) Inventors: Mu-Chuan Wu, Tainan Hsien (TW); Joseph Wu, Tainan Hsien (TW); Mi-Ching Tsai, Tainan (TW); Bor-Jeng Lin, Tainan (TW); Jia-Sheng Hu, Tainan (TW)

Correspondence Address: BACON & THOMAS, PLLC, 625 SLATERS LANE, FOURTH FLOOR, ALEXANDRIA, VA, 22314, US

(73) Assignee: Tonic Fitness Technology, Inc., Tainan Hsien (TW)

(21) Appl. No.: 10/445,903

(22) Filed: May 28, 2003

(51) Int. Cl. G06G 7/48

(52) U.S. Cl. 703/6

(57) ABSTRACT

A dynamic platform with a reality-simulating device includes a base, an inclining mechanism, a swaying mechanism, and a dynamic platform. The inclining mechanism has two inclining shaft frames respectively striding on support members of the base, driven by a motor to incline. A frame base is respectively provided between two non-pivoted ends of the two inclining shaft frames. The swaying mechanism is pivotally connected with the inclining mechanism, having a swaying frame and two swaying plates extending down and pivotally connected with the frame bases of the inclining mechanism. Two spiral gears are provided on the base and driven by another motor for moving the swaying mechanism. The dynamic platform is placed on the swaying mechanism, with an exercise appliance placed thereon, and with a screen provided beside the platform.

### BACKGROUND OF THE INVENTION

1. Field of the Invention

This invention relates to a dynamic platform with a reality-simulating device, particularly to one for accurately simulating real conditions or circumstances on the platform with various devices possible to be placed thereon for a user making use of the device to realize a reality simulating condition.

2. Description of the Prior Art

At present, a conventional reality simulating platform mostly uses the Steward platform mechanism, making use of an oil pressure cylinder for linear movement and rotation of the platform, having features of enduring heavy load, moving flexibly, but too complicated in its position control for easy calculation, and having some problems in the oil route system.

### SUMMARY OF THE INVENTION

This dynamic platform with a reality simulating device includes a base having a support member respectively at two sides, an inclining mechanism having two inclining frames pivotally connected with the support members of the base and moved by a motor, with two non-pivoted ends of each inclining frame connected with a frame base, a swaying mechanism vertically and crossingly connected pivotally with the inclining mechanism and having a horizontal swaying frame provided with two pivotal plates respectively extending down from two sides and pivotally connected with the two frame bases of the inclining mechanism. The swaying mechanism also has a spiral gear units combined on the base and rotated by another motor for controlling and moving the swaying mechanism. Then a platform is mounted on the swaying mechanism so that the platform is moved in various ways to simulate a real condition or circumstances in conjunction with a screen placed beside the platform. Then an exercise appliance such as a stationary bike can be placed on the platform for a person to use the appliance for exercising as through the person were riding the bike or doing exercise.

### BRIEF DESCRIPTION OF DRAWINGS

This invention will be better understood by referring to the accompanying drawings, wherein:

FIG. 1 is a perspective view of a dynamic platform with a reality-simulating device in the present invention;

FIG. 2 is a front view of the dynamic platform with a reality-simulating device in the present invention;

FIG. 3 is a left side view of the dynamic platform with a reality-simulating device in the present invention;

FIG. 4 is a front view of the dynamic platform with a reality simulating device in the present invention, showing it used in a way;

FIG. 5 is a side view of the dynamic platform with a reality-simulating device in the present invention, showing the platform inclined downward to the front;

FIG. 6 is a left side view of the dynamic platform with a reality-simulating device in the present invention, showing the platform with an exercise appliance fixed on being inclined;

FIG. 7 is a side view of the dynamic platform being swayed like a seesaw in the present invention; and,

FIG. 8 is a perspective view of the dynamic platform being swayed right and left, inclined back and forth and turned around in the present invention.

### DETAILED DESCRIPTION OF THE PREFERRED EMBODIMENT

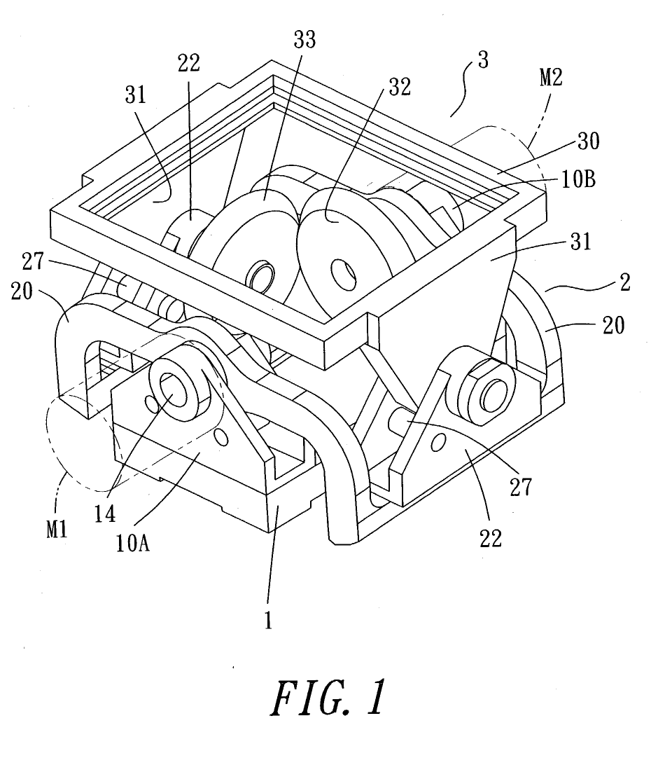

A preferred embodiment of a dynamic platform with a reality-simulating device in the present invention, as shown in FIG. 1, includes a base 1, an inclining mechanism 2, a swaying mechanism 3 and a dynamic platform 4.

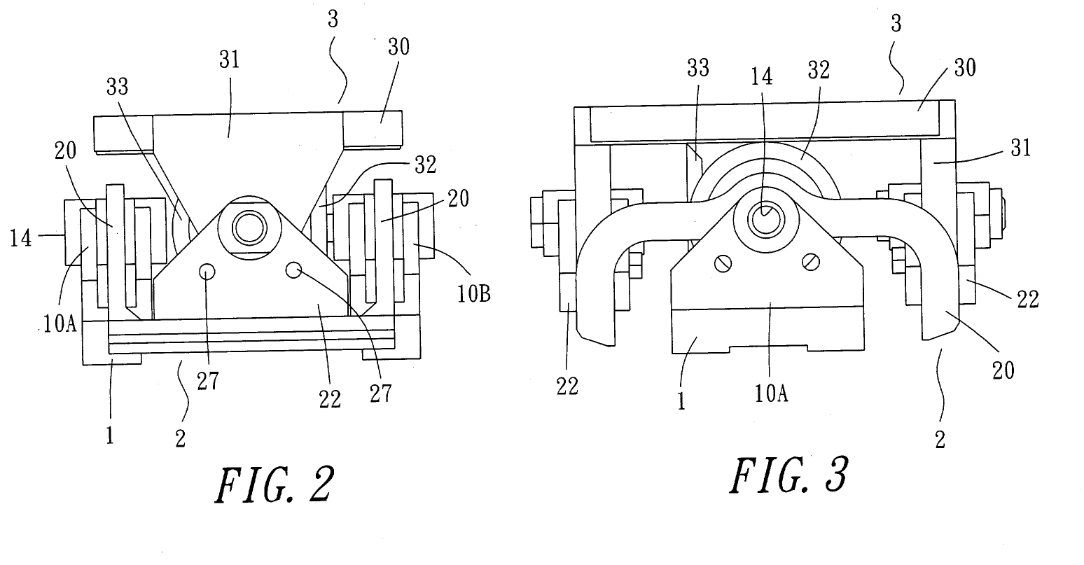

The base 1 has two support members 10A, 10B at two sides separated for a distance. Each support member 10A, 10B has a notch respectively in an upper end and two sides, and an inclining shaft 14 with a center hole is placed on the upper end, as shown in FIG. 2.

The inclining mechanism 2 has two inclining shaft frames 20, which have an intermediate portion striding respectively on the support members 10A, 10B and pivotally connected with the inclining shaft 14. as shown in FIG. 3. So the inclining mechanism 2 can incline and sway back and forth relative to the base 1. Further, a frame base 22 is fixed respectively between the two non-pivoted ends of the two inclining frames 20, as shown in FIGS. 1 and 2, and two rollers 27 are provided spaced apart horizontally on the inner surface of each frame base 22.

The swaying mechanism 3, as shown in FIG. 1, is positioned on the inclining mechanism 2 and pivotally connected with the same mechanism 2, having a horizontal swaying frame 30 of a square-shape with a large center opening with a triangular plate 31 respectively extending down from two opposite sides and pivotally connected with the two frame bases 22. Thus, the inclining and the swaying mechanism 2 and 3 are vertically and crossingly connected pivotally with each other. Further, a first spiral gear 32 is provided at the inner side of the support base 10B pivotally connected with the upper end of the support member 10B, and a second spiral gear 33 is provided adjacent to the first spiral gear 32 and engaging with the first spiral gear 32, as shown in FIGS. 1 and 2. The second spiral gear 33 moves the pivotal plates 31 of the swaying mechanism 3 synchronously.

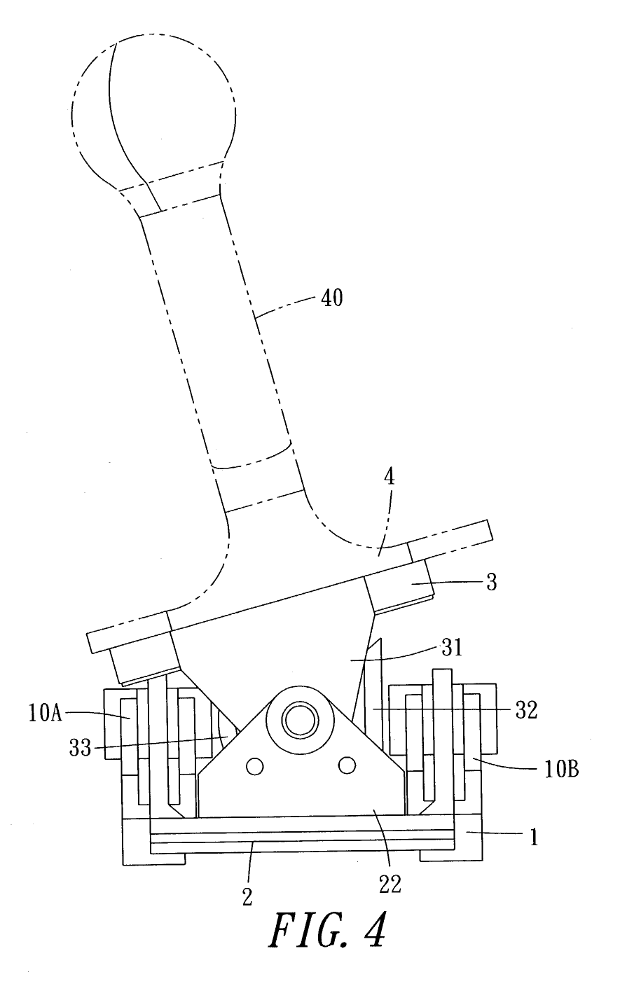

Next, an exercise appliance 40 can be placed on the dynamic platform 4, and moved to incline or sway in various ways by the incline mechanism 2 and the swaying mechanism 3 so that the user might feel as if he/she were riding on a bike on real road, simulating a real condition or circumstance, in conjunction with a screen placed beside the platform 4. For example, an exercise (stationary) bike 40 is placed on the platform 4, as shown in FIG. 4, and a first servomotor M1 is fixed besides the inclining mechanism 2, (as shown in FIG. 1, with a speed reducer possible to be attached to reduce the speed of the motor M1), having its shaft driving the inclining shaft 14 to move up and down the inclining frame 20 like a seesaw.

Further, a second servomotor M2 is provided on the base 1, (also possible to attach with a speed reducer for reducing its speed), having its shaft move the inclining shaft 14. When the second servomotor M2 rotates, it can move the first spiral gear 32, which then rotates the second spiral gear 33 synchronously, causing the swaying frame 30 of the swaying mechanism 3 to move like a seesaw.

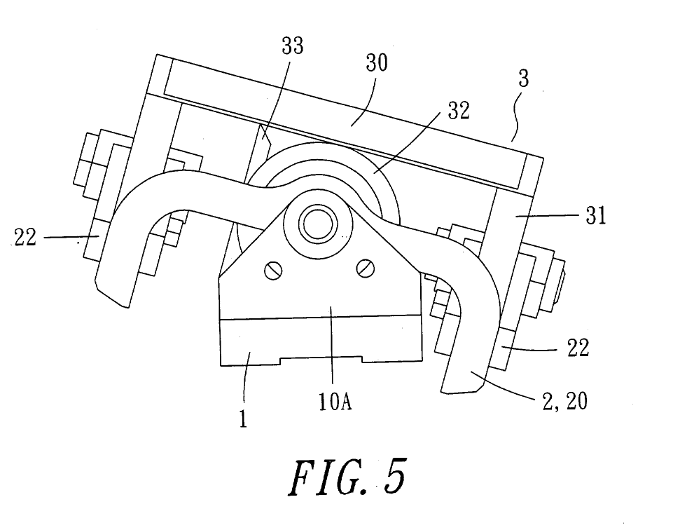

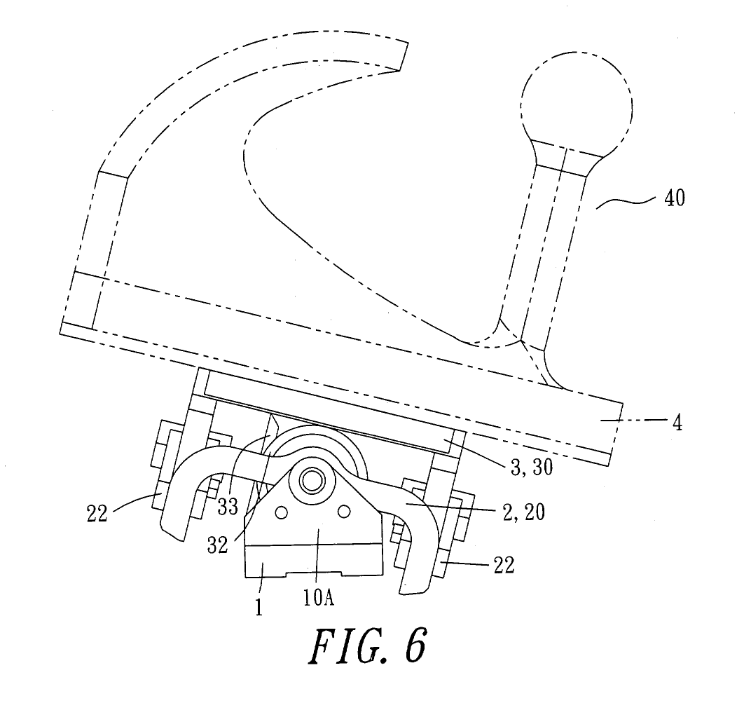

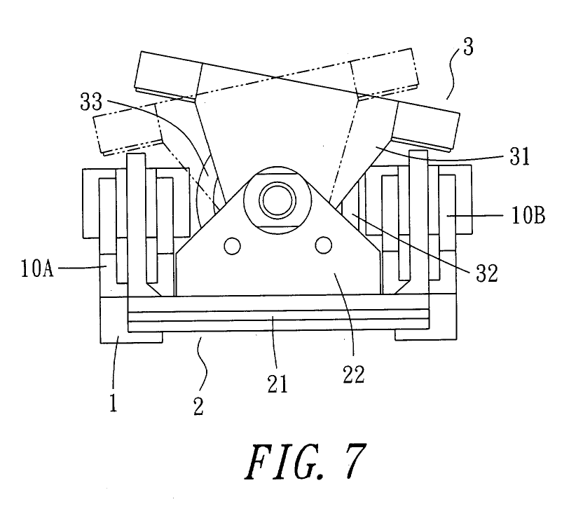

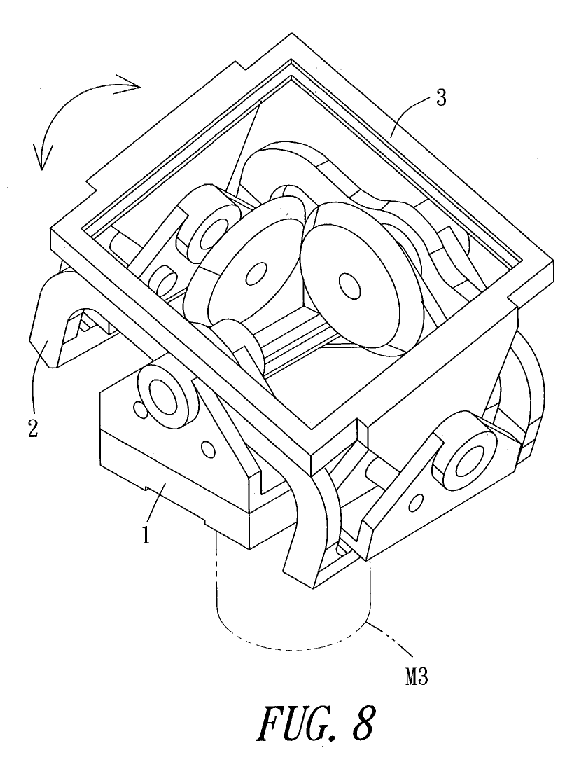

Therefore, if the invention is used in conjunction with the two servomotors M1, M2 and a screen showing a real road condition, it can attain the function of reality simulation. For example:
1. If the screen shows an up-slope road, the first servomotor M1 is selected to drive the inclining mechanism 2 to force the platform 4 with the exercise bike 40 incline rearward, as shown in FIGS. 5 and 6, as through a user sitting on the bike were riding on a real up-slope.
2. If the screen shows a down-slope, the first servomotor M1 is also selected to rotate reversely to move the inclining mechanism 2 incline to the front so that the platform 4 with the exercise bike 40 may also incline to the front, as if the user sitting on the bike were riding down a real down-slope.
3. If the screen shows a side-inclining road, the second servomotor M2 is controlled to drive the swaying mechanism 3 sway to the left and the right, as shown in FIG. 7, with the platform 4 with the exercise bike 40 also sway in the same way, as through the user were riding a bike on a real side-inclining road.
4. When the screen shows a corner of a road, the two servomotors M1 and M2 are both used to drive the two mechanism 2 and 3 at the same time, as shown in FIG. 8, forcing the platform 4 with the exercise bike 40 also turning round as through the user sitting on the bike were turning around a real corner.

In addition, the base 1 can add a third servomotor M3 to control rotation, as shown in FIG. 6, enabling the dynamic platform 4 with the reality simulating device to be provided with a real perception of turning around, by the third motor M3 (possible also to attach with a speed reducer) used to control the base 1 together with the two servo motors M1 and M2.

The dynamic platform with a reality-simulating device in the invention has the following advantages, if compared with the conventional Stewart platform mechanism.

1. As the platform has to endure a heavy load, the first motor M1 is positioned on the base, lightening the weight from the platform 4 so as to avoid vibration of the first motor M1 not to be transmitted to the platform 4.
2. There is no such problems of uneasy calculation for analyzing position control of the conventional Stewart platform, and the motors are used to directly drive the shafts to carry out inclination and swaying, electrically controlling the position of the platform stably, quickly and easily.
3. The spiral gears are used for force transmission for rotating two shafts at the same time, instead of the transmitting device using three shafts in series that is liable to cause error interference and a gap problem in the conventional platform, which the platform in the invention does not have.
4. Various exercise appliances can be positioned on the platform in the invention, performing exercise by three shafts moving at the same time. In case of swaying right and left, torque inertia is comparative large, so the invention makes use of a pair of rollers respectively at the support members 10A and 10B and at the two sides of the frame base 22 for enduring the torque.

While the preferred embodiment of the invention has been described above, it will be recognized and understood that various modifications may be made therein and the appended claims are intended to cover all such modifications that may fall within the spirit and scope of the invention.

1. A dynamic platform with a reality simulating device comprising:
A base having a support member respectively at a left and a right side and separated by a distance, each said support member having its upper end supporting an inclining shaft:
A inclining mechanism consisting of two inclining shaft frames, each said inclining shaft frame having its intermediate portion striding on each said support member of said base and pivotally connected stably, a frame base provided between two non-pivoted ends of said two inclining frames and connecting said two ends, said inclining mechanism making inclining movement by a motor:
A swaying mechanism having a horizontal swaying frame, said swaying frame having a pivotal plate respectively extending down from two opposite sides and pivotally connected with said frame bases so that said inclining mechanism and said swaying mechanism vertically and crossingly connected with each other pivotally, a spiral gear unit provided on said base, said spiral gear unit having a first spiral gear driven by a motor to rotate, said first spiral gear engaging with a second spiral gear and rotating to force said second mechanism sway up and down like a seesaw: and,
A dynamic platform placed on said swaying mechanism, an exercise appliance such as an exercise (stationary) bike placed on said dynamic platform, a screen placed beside said platform and said exercise appliance, said two motors moving said inclining mechanism and said swaying mechanism to let said dynamic platform incline and sway so that a user may feel as if he/she were really riding a bike or doing exercise.

2. The dynamic platform with a reality simulating device as claimed in claim 1, wherein said base is controlled by another motor for rotating to have a turning around function.

3. The dynamic platform with a reality simulating device as claimed in claim 1, wherein said motors are servomotors all attached with a speed reducer.
